(19) United States
(12) Patent Application Publication
(10) Pub. No.: US 2018/0266636 A1
(43) Pub. Date: Sep. 20, 2018

(54) LIGHTING DEVICE AND CORRESPONDING METHOD

(71) Applicant: OSRAM GmbH, Munich (DE)

(72) Inventors: Marco Barp, Treviso (IT); Nicola Schiccheri, Padova (IT); Alessandro Bizzotto, Castelfranco Veneto (IT)

(21) Appl. No.: 15/917,921

(22) Filed: Mar. 12, 2018

(30) Foreign Application Priority Data
Mar. 16, 2017 (IT) 102017000029018

(51) Int. Cl. F21K 9/278; F21V 23/06; H05B 33/08

(52) U.S. Cl. CPC F21K 9/278; F21Y 2103/10; H05B 33/0809; F21V 23/06

(57) ABSTRACT

A lighting device and corresponding method are described herein. In various aspects, the lighting device may be implemented as an electrically powered lighting device (e.g., a C5W lamp). The lighting device may include a first electrical supply contact and a second electrical supply contact. The lighting device may also include one or more light emitting diodes disposed between a first terminal and a second terminal, such that the light emitting diode(s) may be conductive from the first terminal towards the second terminal. The lighting device may further include a rectifier circuit that contains first and second rectifier branches being conductive from the first supply contact towards the first terminal and from the second terminal towards the second supply contact, respectively; and third and fourth rectifier branches being conductive from the second supply contact towards the first terminal and from the second terminal towards the first supply contact, respectively.

### CROSS-REFERENCE TO RELATED APPLICATION

This application claims priority to Italian Patent Application Serial No. 102017000029018, which was filed on Mar. 16, 2017, and is incorporated herein by reference in its entirety and for all purposes.

### TECHNICAL FIELD

The present description relates to lighting devices.

One or more embodiments may refer to lighting devices employing solid-state electrically powered light radiation sources, e.g. LED sources.

### BACKGROUND

The introduction and the ever-increasing diffusion of solid-state light radiation sources, such as LED sources, has opened new prospects in the implementation of lighting devices.

This regards e.g. the possible retrofitting of traditional light radiation sources, such as filament lamps, thus offering better performances from a mechanical, electrical, thermal and optical point of view.

In this respect, an interesting feature may consist in the possibility of inserting the lighting device into its mounting seat without the need of considering the power supply polarity (which is typically direct in the automotive sector), the consequent possibility being offered of achieving the lighting up of the lighting device irrespective of the polarity, so as to enable operation e.g. either with a positive supply voltage V_{DD} or with a negative supply voltage V_{SS}.

Another positive aspect may regard the compact size, the possibility being given e.g. of implementing lighting devices in the form of C5W bulbs, to be used in the automotive sector.

Document EP 3 099 141 A1, owned by the same Applicants, discloses a lighting device including the series connection of a plurality of light emitting diode cells, which may be activated by a supply voltage applied across said series connection, wherein said light emitting diode cells include a first diode and a second diode arranged in parallel with opposite polarities, so that the first diodes and the second diodes may be activated alternatively, as a function of the polarity of the voltage applied across said series connection of light emitting diode cells. In practice, said solution envisages the combination of two lighting devices, adapted to be activated alternatively according to the polarity of the voltage supply.

Solutions according to such prior art document may envisage, for example:

the presence, on both sides of a substrate, of LED strings having opposite polarity, mutually connected in cascade and with the first and the last LED on each side adapted to receive the supply voltage,

the presence, on each side of the substrate, of LEDs alternatively having opposite polarities, with one LED on one side connected to at least one LED on an opposite side (e.g. through an electrically conductive via traversing the substrate) so as to create a serpentine conductive path which connects the LEDs having the same polarity, the possibility being offered of obtaining a better distribution and uniformity of the emitted light radiation,

the arrangement, on the same side of the substrate, of two LED strings having once again opposite polarity, the LEDs of each string being mutually connected in cascade, with the first and the last LED of each cascade being again adapted to receive the supply voltage.

As stated in the mentioned document, said solutions may offer various advantages.

However, at least in some applications, the choice of “doubling” the device may cause drawbacks as regards both cost and size.

In order to obtain the lighting up of a light radiation source irrespective of the polarity of the supply voltage, a rectifier circuit may be used (as shown e.g. in U.S. Pat. No. 7,906,915 B2 in order to light up a pushbutton).

The possibility of using a rectifier circuit is also mentioned in EP 3 099 141 A1; however, such a solution is not always practicable, e.g. when a small-sized lighting source is desired.

### SUMMARY

One or more aspects of the embodiments aim at overcoming the previously outlined drawbacks.

According to one or more embodiments, said aspects may be achieved thanks to a lighting device having the features specifically set forth in the present disclosure.

One or more embodiments may also refer to a corresponding method.

The claims are an integral part of the technical teaching provided herein with reference to embodiments.

One or more embodiments may enable achieving a LED lighting source which may be activated irrespective of the supply polarity.

One or more embodiments may employ light emitting diodes (LEDs) of the Chip Scale Package (CSP) type, which may have a smaller footprint than other LEDs, together with a radiation pattern having a width of 150° or more and a wide range of possible colour temperatures (CCTs) and colours.

In one or more embodiments, the light radiation sources (LEDs) may be mounted onto a planar support, such as e.g. a Printed Circuit Board (PCB), e.g. an FR4 PCB.

One or more embodiments may offer one or more of the following advantages: possibility of plugging in the lighting device without the need of considering the electrical polarity, small size.

### BRIEF DESCRIPTION OF THE DRAWINGS

One or more embodiments will now be described, by way of non-limiting example only, with reference to the annexed Figures, wherein:

FIG. 1 is a schematic view of a lighting device according to one or more embodiments,

FIG. 2 is a diagram exemplifying operating criteria of one or more embodiments,

FIGS. 3, 4 and 5 exemplify various possible embodiments.

It will be appreciated that, for simplicity and clarity of illustration, the views in the various Figures may not be drawn to the same scale.

### DETAILED DESCRIPTION

In the following description, various specific details are given to provide a thorough understanding of exemplary embodiments. One or more embodiments may be practiced without one or several specific details, or with other methods, components, materials, etc. In other instances, well-known structures, materials or operations are not shown or described in detail in order to avoid obscuring various aspects of the embodiments.

Reference throughout this specification to “one embodiment” or “an embodiment” means that a particular feature, structure, characteristic described in connection with the embodiment is included in at least one embodiment. Thus, the possible appearances of the phrases “in one embodiment” or “in an embodiment” in various places throughout this specification are not necessarily all referring exactly to the same embodiment. Furthermore, particular features, structures, or characteristics may be combined in any suitable manner in one or more embodiments.

The headings provided herein are for convenience only, and therefore do not interpret the extent of protection or scope of the embodiments.

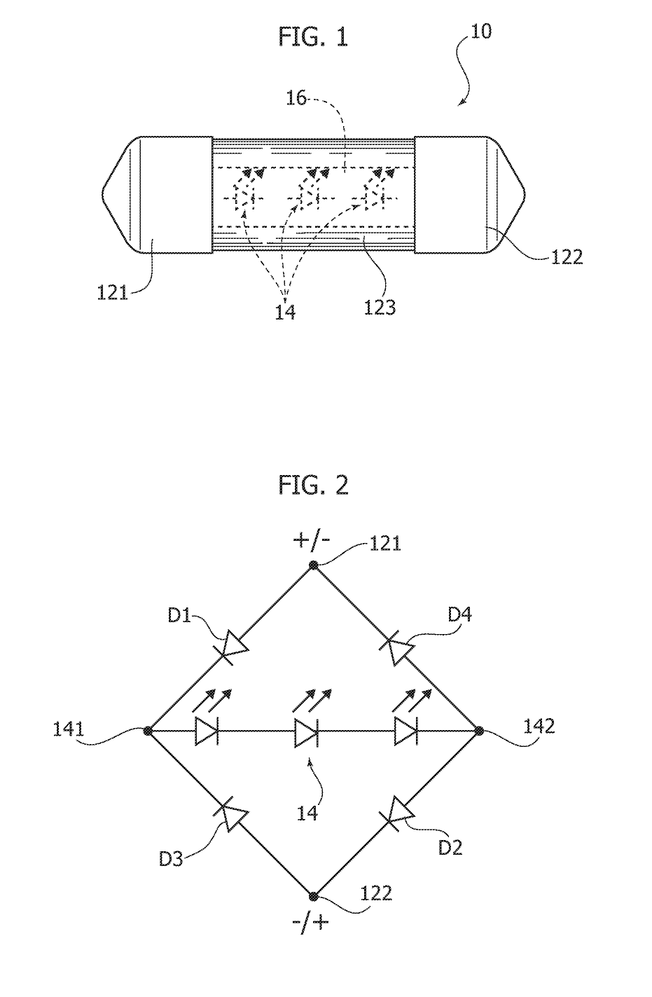

In FIG. 1, reference numeral 10 generally denotes a lighting device.

Possible applications of device 10 may include e.g. the automotive sector or the sector of interior lighting. In one or more embodiments, the lighting device may be adapted to be used e.g. as a retrofit device, for replacing a filament bulb e.g. as a C5W lamp.

Of course, the reference both to the possible use as a retrofit device and to said possible application sectors is merely exemplary and does not limit the embodiments.

In one or more embodiments, device 10 may be implemented (again by way of non-limiting example only) as a so-called festoon bulb, including an elongated rod adapted to be mounted into a housing including two power supply contacts (rheophores) 121, 122, which may have a cap shape; an e.g. tubular transparent (i.e. light-permeable) housing 123 (e.g. made of glass or transparent plastic material) extends between said caps.

In one or more embodiments (see e.g., for simplicity, FIG. 1), device 10 may include a substrate 16 implemented as a Printed Circuit Board (PCB), e.g. an FR-4 PCB, adapted to extend between contacts 121 and 122 along housing 123, and to carry one or more electrically powered light radiation sources 14, the radiation whereof may diffuse outside housing 123.

In one or more embodiments, the light radiation source(s) may include solid-state sources, such as sources including Light Emitting Diodes (LEDs).

In the same way as the solutions disclosed in EP 3 099 141 A1, one or more embodiments may take into account that, e.g. according to the mounting position or direction of device 10, the supply voltage V (e.g. direct voltage) applied between contacts or rheophores 121, 122 may have opposite polarities, and therefore may be either a “positive” voltage or a “negative” voltage.

The problem of the polarity or direction of the supply voltage does not occur in the case of traditional filament lamps, the behaviour whereof does not vary as a function of polarity. On the contrary, the polarity of the supply voltage acquires importance in the case of LED sources 14, which are adapted to emit light when the supply voltage has a given polarity (positive anode with respect to the cathode), therefore exhibiting the electrical behaviour of a diode.

In one or more embodiments, the device 10 exemplified herein may include one or more light emitting diodes 14, set between a first terminal 141 and a second terminal 142.

The phrase “light emitting diode” is used herein in lieu of the more currently used acronym (LED) in order to highlight that such component(s) exhibit their ability to emit light radiation while having the electrical behaviour of a diode, i.e. of a component having an anode and a cathode and being adapted to be electrically conductive (and to emit light radiation) when subjected to a direct voltage, i.e. with the anode having a higher potential level than the cathode.

For the purposes of the present exemplary description, it will be assumed that the light emitting diode(s) 14 are set between the terminals 141 and 142, so as to be conductive (and to originate a light radiation emission) in the conduction direction from the first terminal 141 to the second terminal 142.

For example, in the presence of a plurality of diodes 14 it may be assumed that they are electrically series-connected in cascade, i.e. with the cathode of one diode connected to the anode of the subsequent diode in the cascade. It will be appreciated, moreover, that in one or more embodiments it is also possible to envisage the presence of a plurality of diodes 14 mutually connected in parallel (anode to anode and cathode to cathode) or of mixed series-parallel connections.

As previously stated, one or more embodiments may tackle with the problem that the contacts or rheophores 121, 122 may be exposed to a supply voltage V which may be either “positive”, with contact 121 having a higher potential than contact 122, or “negative”, with contact 11 having a lower potential than contact 122.

The polarity of the supply voltage (a negligible feature in the traditional filament lamps, the behaviour whereof remaining unvaried as a function of the polarity of the supply voltage) becomes relevant in the case of LED light radiation sources, which exhibit the electrical behaviour of a diode, as they operate and emit light when the supply voltage has a given polarity (the anode is positive with respect to the cathode).

One or more embodiments may envisage the presence of a rectifier circuit which is adapted, in one or more embodiments, to correspond to the general diagram exemplified in FIG. 2, and therefore may include:

first and second rectifier branches (e.g. two diodes D1 and D2) which extend from the first contact 121 towards the first terminal 141 and from the second terminal 142 towards the second contact 122, respectively, with the ability to be conductive in the direction from the first contact 121 to the first terminal 141 and from the second terminal 142 towards the second contact 122, and
third and fourth rectifier branches (e.g. two diodes D3 and D4) which extend from the second contact 122 towards the first terminal 141 and from the second terminal 142 towards the first contact 121, respectively, having the ability to be conductive in the direction from the second contact 122 to the first terminal 141 and from the second terminal 142 towards the first contact 121.

It will be appreciated that, in one or more embodiments, said rectifier circuit may be implemented by “normal” diodes, i.e. diodes D1, D2, D3 and D4 which do not exhibit light emitting features.

From the observation of FIG. 2 it is possible to infer that the related rectifier circuit is substantially similar to a bridge rectifier circuit, adapted to make the light emission diode or (all) the light emission diodes 14 conductive and therefore adapted to emit light radiation—irrespective of the polarity of the supply voltage applied between contacts 121 and 122 (e.g. in such a way that, irrespective of the polarity of the supply voltage applied between contacts 121 and 122, terminal 141 has a higher potential than terminal 142).

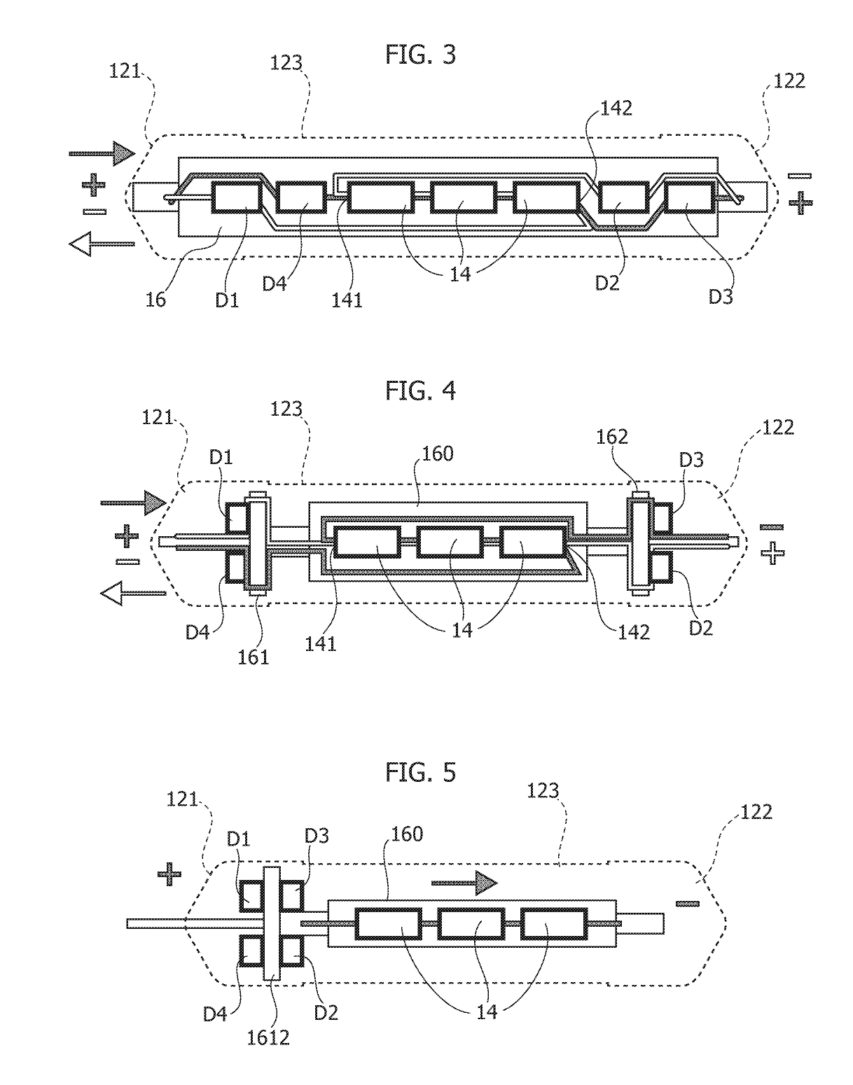

FIG. 3 exemplifies one or more embodiments wherein the light emitting diodes 14 are arranged on a substrate 16 which may include, in one or more embodiments, a laminar substrate, e.g. a rod-shaped substrate which is substantially similar to a Printed Circuit Board (PCB), extending between contacts 121 and 122.

In one or more embodiments, substrate 16 may include a PCB currently denoted as FR4.

In one or more embodiments as exemplified in FIG. 3, both the light emitting diodes 14 and the diodes D1, D2, D3, D4 of the rectifier circuit may be mounted on a common substrate 16, with the end contacts or rheophores 121 and 122 protruding from the ends of substrate 16.

FIGS. 4 and 5 exemplify embodiments wherein the substrate may include:

a main portion 160, adapted to host the light emitting diodes 14, one or two appendix portions (161, 162 in FIG. 4; 1612 in FIG. 5) adapted to host the diodes D1, D2, D3, D4 of the rectifier circuit.

FIG. 4 exemplifies one or more embodiments which may envisage two appendix portions 161, 162 which are adapted to host, respectively:

the diodes D1, D4 to be connected to contact 121, and
the diodes D2, D3 to be connected to contact 122.

On the other hand, FIG. 5 exemplifies one or more embodiments which may envisage only one appendix portion 1612, adapted to host all four diodes D1, D2, D3, D4 of the rectifier circuit.

One or more embodiments may therefore enable the arrangement of the light emitting diodes 14 and of the diodes D1, D2, D3 and D4 of the rectifier circuit in two different portions of the substrate, therefore preventing the components of the rectifier circuit from hampering the propagation of the light radiation, in spite of their arrangement on the same surface or face of substrate 16 hosting the light emitting diodes 14.

In one or more embodiments, therefore, the substrate (at least in the portion hosting the light emitting diodes 14) may include a light-permeable material (e.g. a transparent material) in order to obtain a substantially uniform light radiation distribution around the longitudinal axis of device 10.

In one or more embodiments, the electrically conductive lines or tracks connecting the rectifier circuit to the light emitting diodes 14 (see e.g. FIGS. 3 and 4) may be rather thin and/or may be made of light permeable materials, so as not to affect light radiation propagation appreciably.

In one or more embodiments it is moreover possible to distribute the light emitting diodes 14 on both opposite faces of substrate 16, so as to obtain a substantially uniform light radiation distribution around the longitudinal axis of device 10.

In one or more embodiments, hosting the diodes of the rectifier circuit on one or more appendix portions 161, 162 or 1612 of the substrate may enable arranging said appendix portion(s) sidewise of the (e.g. central) portion 160 hosting the light emitting diodes 14.

As exemplified in FIGS. 4 and 5, the side appendix portion(s) 161, 162, 1612 may therefore be arranged within at least one or both contacts 121, 122, which may have a cap-like shape and may therefore be adapted to host the components of the rectifier circuit therein (thus protecting and concealing them from the outside).

In addition, the main portion 160 with the light emitting diodes 14 extends e.g. at the light permeable central portion 123 of device 10.

It will be remarked, moreover, that a solution as exemplified in FIG. 5, having a main portion 160 carrying the light emitting diodes 14 and one (single) side appendix portion 1612 hosting the diodes D1, D2, D3, D4 of the rectifier circuit, may be used in lighting devices 10 wherein (unlike the exemplary embodiments of the Figures, wherein contacts 121 and 122 are arranged at opposite ends of device 10) the contacts 121 and 122 are arranged (e.g. in a cap-shaped element) at one end of device 10, near the side appendix portion 1612 hosting diodes D1, D2, D3, D4.

This may be the case, for example, of LED lighting devices which are adapted to reproduce the shape of traditional teardrop bulbs (e.g. halogen lamps) provided with threadlike contacts adapted to be inserted as a plug in respective holes or cavities of a mounting basis; therefore, once again, in the case of LED sources the problem may arise—unlike incandescent sources—of the polarity or direction of the supply voltage.

With reference, by way of example only, to the automotive sector, one or more embodiments as considered herein may be applied to lamps provided with a wedge socket, such as P27W, P27/5W, W21W, W21/5, W5W, W10W, W15/5W and other similar lamps. As a matter of fact, said socket may not guarantee the correct polarity of the circuit, because the lamp may be inserted in the reverse position into the socket.

In these devices, the rectifier diodes D1, D2, D3 and D4 may either be placed into the inner volume of the socket, and may be connected to the array of light emitting diodes 14, or they may be arranged near the light emitting diodes 14 while sharing the same support 16 of the latter.

Thus, one or more embodiments enable achieving a LED lighting device 10 adapted to exhibit, as far as its outer appearance is concerned, features substantially similar to a traditional bulb (e.g. a C5W lamp), the possibility being given to make the operation of device 10 independent from the mounting direction, i.e. independent from the direction of the supply voltage applied between contacts 121, 122.

One or more embodiments may therefore concern an electrically powered lighting device (e.g. 10), including:

a first (e.g. 121) and a second (e.g. 122) electrical supply contact;

at least one light emitting diode (e.g. 14) set between a first terminal (e.g. 141) and a second terminal (e.g. 142), the at least one light emitting diode being conductive (with direct polarization, the anode having a higher potential than the cathode) from said first terminal towards said second terminal; and

a rectifier circuit, including:
first (e.g. D1) and second (e.g. D2) rectifier branches, said first and second rectifier branches being conductive from said first supply contact towards said first terminal and from said second terminal towards said second supply contact, respectively, and
third (e.g. D3) and fourth (e.g. D4) rectifier branches, said third and fourth rectifier branches being conductive from said second supply contact towards said first terminal and from said second terminal towards said first supply contact, respectively.

In one or more embodiments, the diodes of the rectifier circuits may be “normal” diodes, e.g. diodes that do not emit light.

One or more embodiments may include a plurality of light emitting diodes set between said first terminal and said second terminal, the plurality of light emitting diodes being conductive from said first terminal towards said second terminal.

In one or more embodiments, said plurality of light emitting diodes may include a string of series-connected light emitting diodes.

One or more embodiments may include a housing (e.g. 123) light-permeable at least at said at least one light emitting diode.

One or more embodiments may include at least one substrate (e.g. 16 in FIG. 3; 160, 161, 162 in FIG. 4; 160, 1612 in FIG. 5) with said at least one light emitting diode and said rectifier circuit arranged on said substrate.

In one or more embodiments, said at least one substrate may include light-permeable material at least at said at least one light emitting diode.

In one or more embodiments, said at least one substrate may include:

a main portion (e.g. 160) with said at least one light emitting diode,
at least one appendix portion (e.g. 161, 162; 1612) with said rectifier circuit (D1, D2, D3, D4).

One or more embodiments may include two appendix portions (e.g. 161, 162) in the substrate, with:

said first and said fourth rectifier branch, and

said second e said third rectifier branch, respectively.

In one or more embodiments, said at least one of said first and second supply contacts may include a containment member (e.g. a cap-shaped contact or a socket) hosting at least one rectifier branch of the rectifier circuit.

A method of providing an electrically powered lighting device according to one or more embodiments may include:

providing a first and a second electrical supply contact;

setting at least one light emitting diode between a first terminal and a second terminal, the at least one light emitting diode being conductive from said first terminal towards said second terminal; and

providing a rectifier circuit including:
first and second rectifier branches, said first and second rectifier branches being conductive from said first supply contact towards said first terminal and from said second terminal towards said second supply contact, respectively, and
third and fourth rectifier branches, said third and fourth rectifier branches being conductive from said second supply contact towards said first terminal and from said second terminal towards said first supply contact (121), respectively.

Without prejudice to the basic principles, the implementation details and the embodiments may vary, even appreciably, with respect to what has been described herein by way of non-limiting example only, without departing from the extent of protection.

The extent of protection is indicated by the present disclosure and all changes which come withing the meaning and range of equivalency of the present disclosure are intended to be embraced.

What is claimed is:

1. An electrically powered lighting device, comprising:
a first electrical supply contact and a second electrical supply contact;
at least one light emitting diode disposed between a first terminal and a second terminal, the at least one light emitting diode being conductive from said first terminal towards said second terminal; and
a rectifier circuit including:
first and second rectifier branches, said first and second rectifier branches being conductive from the first supply contact towards said first terminal and from said second terminal towards the second supply contact, respectively, and
third and fourth rectifier branches, said third and fourth rectifier branches being conductive from the second supply contact towards said first terminal and from said second terminal towards the first supply contact, respectively.

2. The lighting device of claim 1,
wherein the at least one light emitting diode includes a plurality of light emitting diodes disposed between said first terminal and said second terminal, and
the plurality of light emitting diodes are conductive from said first terminal towards said second terminal.

3. The lighting device of claim 2,
wherein said plurality of light emitting diodes include a string of series-connected light emitting diodes.

4. The lighting device of claim 1, further comprising:
a housing that is light-permeable at least at said at least one light emitting diode.

5. The lighting device of claim 1, further comprising:
at least one substrate configured to host said at least one light emitting diode and said rectifier circuit.

6. The lighting device of claim 5,
wherein said at least one substrate includes a light-permeable material at least at said at least one light emitting diode.

7. The lighting device of claim 5,
wherein said at least one substrate includes:
a main portion configured to host said at least one light emitting diode, and
at least one appendix portion configured to host said rectifier circuit.

8. The lighting device of claim 7,
wherein the at least one appendix portion includes two appendix portions, such that
a first appendix portion of said two appendix portions is configured to host the first rectifier branch and the fourth rectifier branch, and
a second appendix portion of said two appendix portions is configured to host the second rectifier branch and the third rectifier branch.

9. The lighting device of claim 1,
wherein at least one of the first supply contact or the second supply contact includes a containment member configured to host at least one rectifier branch of the rectifier circuit.

10. A method of providing electrically powered lighting devices, the method comprising:
providing a first electrical supply contact and a second electrical supply contact;
setting at least one light emitting diode between a first terminal and a second terminal, the at least one light emitting diode being conductive from said first terminal to said second terminal; and
providing a rectifier circuit including:
first and second rectifier branches, said first and second rectifier branches being conductive from the first supply contact towards said first terminal and from said second terminal towards the second supply contact, respectively, and
third and fourth rectifier branches, said third and fourth rectifier branches being conductive from the second supply contact towards said first terminal and from said second terminal towards the first supply contact, respectively.

11. The method of claim 10,
wherein the at least one light emitting diode includes a plurality of light emitting diodes set between said first terminal and said second terminal, and
the plurality of light emitting diodes are conductive from said first terminal towards said second terminal.

12. The method of claim 11,
wherein said plurality of light emitting diodes include a string of series-connected light emitting diodes.

13. The method of claim 12,
wherein said plurality of light emitting diodes include a string of series-connected light emitting diodes.

14. The method of claim 10, further comprising:
providing a housing that is light-permeable at least at said at least one light emitting diode.

15. The method of claim 10, further comprising:
providing at least one substrate configured to host said at least one light emitting diode and said rectifier circuit.

16. The method of claim 15,
wherein said at least one substrate includes a light-permeable material at least at said at least one light emitting diode.

17. The method of claim 15,
wherein said at least one substrate includes:
a main portion configured to host said at least one light emitting diode, and
at least one appendix portion configured to host said rectifier circuit.

18. The method of claim 17,
wherein the at least one appendix portion includes two appendix portions, such that
a first appendix portion of said two appendix portions is configured to host the first rectifier branch and the fourth rectifier branch, and
a second appendix portion of said two appendix portions is configured to host the second rectifier branch and the third rectifier branch.

19. The method of claim 10,
wherein at least one of the first supply contact or the second supply contact includes a containment member configured to host at least one rectifier branch of the rectifier circuit.

20. The lighting device of claim 4,
wherein the housing comprises a material selected from the group consisting of a light-permeable glass and a light-permeable plastic material.
